(19) United States
(12) Patent Application Publication
(10) Pub. No.: US 2005/0133288 A1
(43) Pub. Date: Jun. 23, 2005

(54) Motor vehicle with a shock-absorbing device for supporting a seat on a vehicle body

(76) Inventor: Samuel Lin, Chia Yi Hsien (TW)

Correspondence Address: MCNEES, WALLACE & NURICK LLC, 100 PINE STREET, P.O. BOX 1166, HARRISBURG, PA, 17108-1166, US

(21) Appl. No.: 10/742,084

(22) Filed: Dec. 19, 2003

(51) Int. Cl. B62K 5/02; B62D 61/06

(52) U.S. Cl. 180/210

(57) ABSTRACT

A motor vehicle includes a wheeled vehicle body, a driving device for driving the vehicle body to move on the ground, a seat, and a shock-absorbing device for supporting the seat on the vehicle body. The shock-absorbing device includes a vertical mounting tube fixed on the vehicle body, and a damping unit disposed between the mounting tube and the seat such that the seat can move vertically on the mounting tube and such that the damping unit can retard vertical movement of the seat relative to the mounting tube.

### BACKGROUND OF THE INVENTION

1. Field of the Invention

This invention relates to a motor vehicle that is suitable for a disabled driver, and more particularly to a motor vehicle that includes a shock-absorbing device for supporting a seat on a vehicle body.

2. Description of the Related Art

Although a conventional motor vehicle designed for a disabled driver is provided with some shock-absorbing devices between a vehicle frame and the wheels, a seat of the conventional motor vehicle can still be subjected to a relatively large shock, thereby resulting in discomfort of the disabled driver.

### SUMMARY OF THE INVENTION

The object of this invention is to provide a motor vehicle that includes a shock-absorbing device for supporting a seat on a vehicle body.

According to this invention, a motor vehicle includes a wheeled vehicle body, a driving device for driving the vehicle body to move on the ground, a seat, and a shock-absorbing device for supporting the seat on the vehicle body. The shock-absorbing device includes a vertical mounting tube fixed on the vehicle body, and a damping unit disposed between the mounting tube and the seat such that the seat can move vertically on the mounting tube and such that the damping unit can retard vertical movement of the seat relative to the mounting tube.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a partly exploded perspective view of the preferred embodiment of a motor vehicle according to this invention;

FIG. 2 is an exploded perspective view of the preferred embodiment;

FIG. 3 is a longitudinal sectional view of the preferred embodiment;

FIG. 4 is a fragmentary sectional view of the preferred embodiment taken along Line IV-IV in FIG. 3; and

FIG. 5 is a longitudinal sectional view of the preferred embodiment, illustrating how a seat is moved relative to a vehicle body when the vehicle body is subjected to a shock.

### DETAILED DESCRIPTION OF THE PREFERRED EMBODIMENT

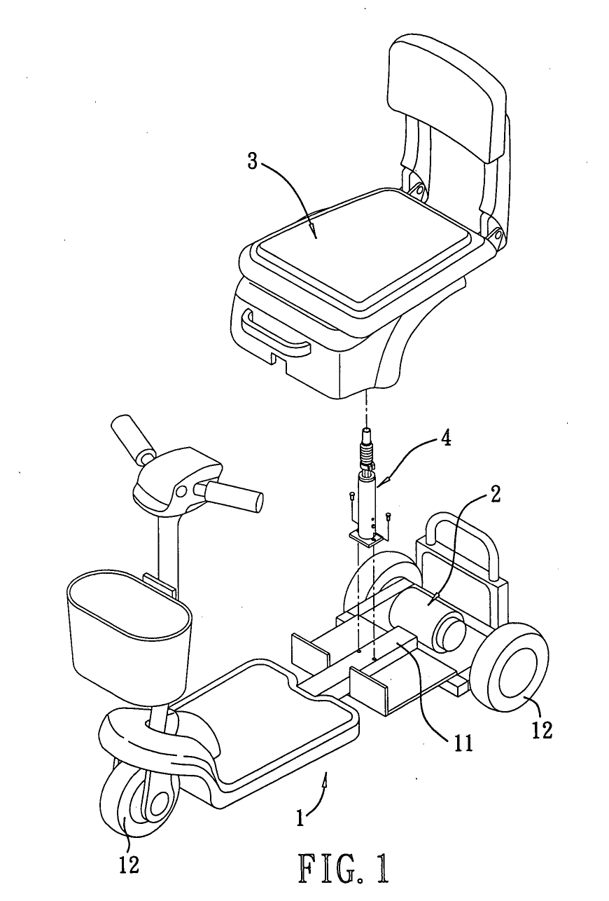

Referring to FIG. 1, the preferred embodiment of a motor vehicle according to this invention is shown to include a wheeled vehicle body 1, a driving device 2, a seat 3, and a shock-absorbing device 4.

The vehicle body 1 includes a vehicle frame 11 and a plurality of wheels 12 mounted rotatably on the vehicle frame 11.

The driving device 2 is mounted on the vehicle frame 11 in a known manner so as to drive the vehicle body 1 to move on the ground.

The seat 3 is supported on the vehicle frame 11 by the shock-absorbing device 4.

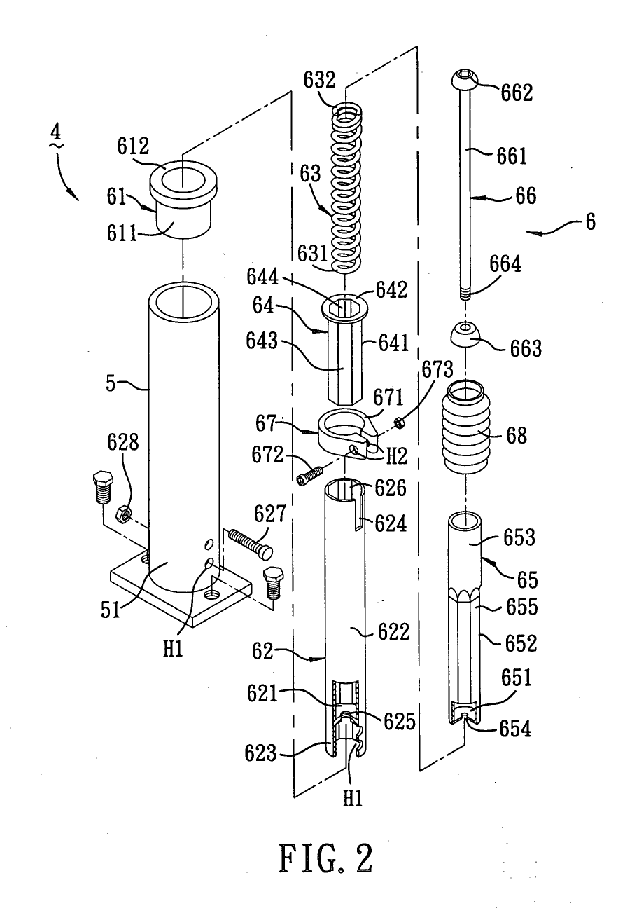

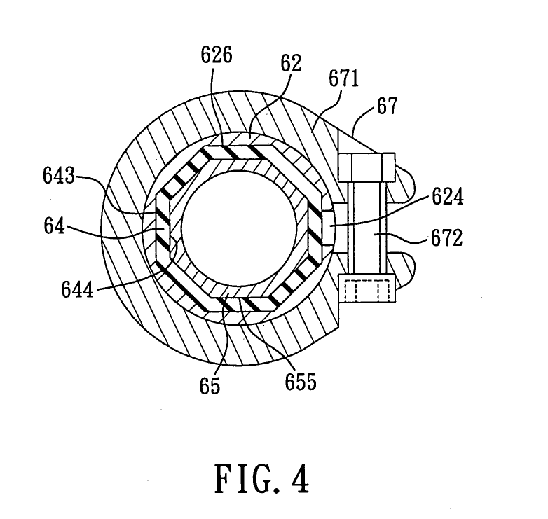

Referring to FIGS. 2, 3, and 4, the shock-absorbing device 4 includes a vertical mounting tube 5 made of metal and fixed on the vehicle frame 11, and a damping unit 6 that is disposed between the mounting tube 5 and the seat 3 such that the seat 3 can move vertically on the mounting tube 5 and such that the damping unit 6 can retard vertical movement of the seat 3 relative to the mounting tube 5. The damping unit 6 includes a lower bushing 61, a vertical outer tube 62, a spring 63, an upper bushing 64, a vertical inner tube 65, a vertical central rod 66, a locking member 67, and a dust-protective sleeve 68. The inner and outer tubes 65, 62 are made of metal.

The outer tube 62 is disposed within the mounting tube 5, and includes a horizontal plate 621 and a tube body 622. The horizontal plate 621 is disposed in and is formed integrally with the tube body 622. Each of the mounting tube 5 and the outer tube 62 has a lower end 51, 623 that is formed with two holes (H1). A horizontal positioning bolt 627 extends through the holes (H1) in the mounting tube 5 and the outer tube 62, and engages a nut 628 so as to fix the outer tube 62 within the mounting tube 5.

The lower bushing 61 is made of a plastic material, and includes a tubular portion 611 and a flange 612 extending radially and outwardly from an upper end of the tubular portion 611. The tubular portion 611 is disposed between an upper end of the mounting tube 5 and the outer tube 62 so as to provide a stable joint between the mounting tube 5 and the outer tube 62 and so as to eliminate noise resulting from contact between the mounting tube 5 and the outer tube 62. The flange 612 abuts against an upper end surface of the mounting tube 5.

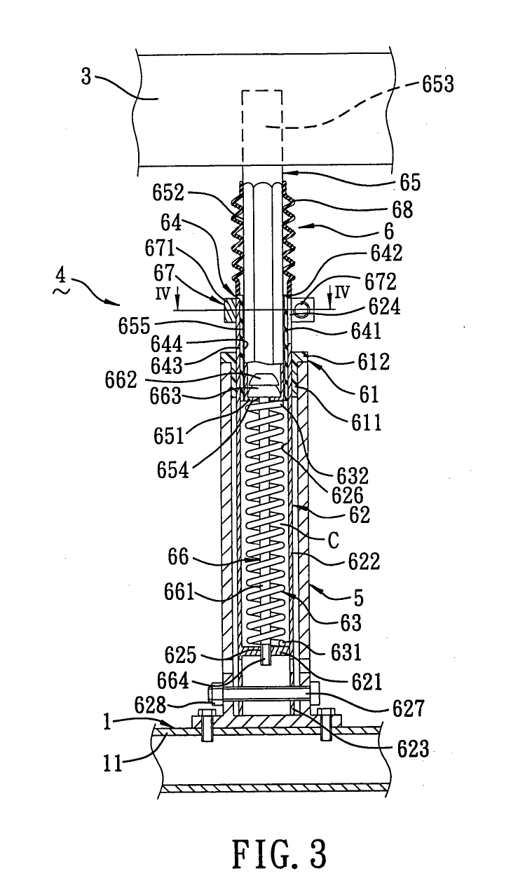

The inner tube 65 is disposed vertically and movably within and projects upwardly from the outer tube 62, and includes a horizontal plate 651 and a tube body 652 that has an upper end 653 connected fixedly to the seat 3. The horizontal plates 651, 621 of the inner and outer tubes 65, 62 define cooperatively a spring-receiving chamber (c) (see FIG. 3) therebetween.

The spring 63 is configured as a coiled compression spring, is disposed within the spring-receiving chamber (c), and has a lower end 631 pressing against the horizontal plate 621 of the outer tube 62, and an upper end 632 pressing against the horizontal plate 651 of the inner tube 65.

The upper bushing 64 is made of rubber, and includes a tubular portion 641 disposed between an upper end of the outer tube 65 and the inner tube 62, a flange 642 extending radially and outwardly from an upper end of the tubular portion 641 and abutting against an upper end surface of the outer tube 62, an octagonal outer surface 643 engaging an octagonal inner surface 626 of the outer tube 62, and an octagonal inner surface 644 engaging an octagonal outer surface 655 of a lower end portion of the inner tube 65. That is, the upper bushing 64 is formed with a central bore having a non-circular cross-section. The inner tube 65 is received fittingly within the upper bushing 64 so as to prevent rotation of the inner tube 65 relative to the upper bushing 64.

Because the lower bushing 61 is disposed between the mounting tube 5 and the outer tube 62 and because the upper bushing 64 is disposed between the inner and outer tubes 65, 62, the manufacturing precision requirement of the mounting tube 5 and the inner and outer tubes 65, 62 can be reduced.

The locking member 67 is used to lock the upper bushing 64 on an upper end portion of the outer tube 62, is configured as a C-shaped clamp, and includes a C-shaped retaining ring 671 sleeved around the upper end portion of the outer tube 62 and having two terminal ends, each of which is formed with a hole (H2), a bolt 672 extending through the holes (H2) in the terminal ends of the C-shaped retaining ring 671, and a nut 673 engaging the bolt 672. The upper end portion of the outer tube 62 is formed with an open-ended slot 624 therethrough so as to permit the outer tube 62 to be sleeved around the upper bushing 64 in a tight fit manner.

The central rod 66 extends through the coiled compression spring 63, and has an upper end 661 that extends through a central hole 654 in the horizontal plate 651 of the inner tube 65, and an externally threaded lower end 664 engaging a threaded hole 625 in the horizontal plate 621 of the outer tube 62 so as to be fastened to the outer tube 62. The upper end 661 of the central rod 66 is formed with a flange unit that is biased by the coiled compression spring 63 to abut against a top surface of the horizontal plate 651 of the inner tube 65. The flange unit includes a flange 662 extending radially and outwardly from the central rod 66, and a rubber washer 663 that is sleeved around the central rod 66 under the flange 662 and that is clamped between the flange 662 and the horizontal plate 651 of the inner tube 65 by virtue of the biasing action of the coiled compression spring 63. As such, the inner tube 65 is biased by the coiled compression spring 63 to move upwardly relative to the outer tube 62 to a predetermined position as shown in FIG. 3.

The dust-protective sleeve 68 is sleeved around the outer tube 62, and has a lower end abutting against the upper bushing 64.

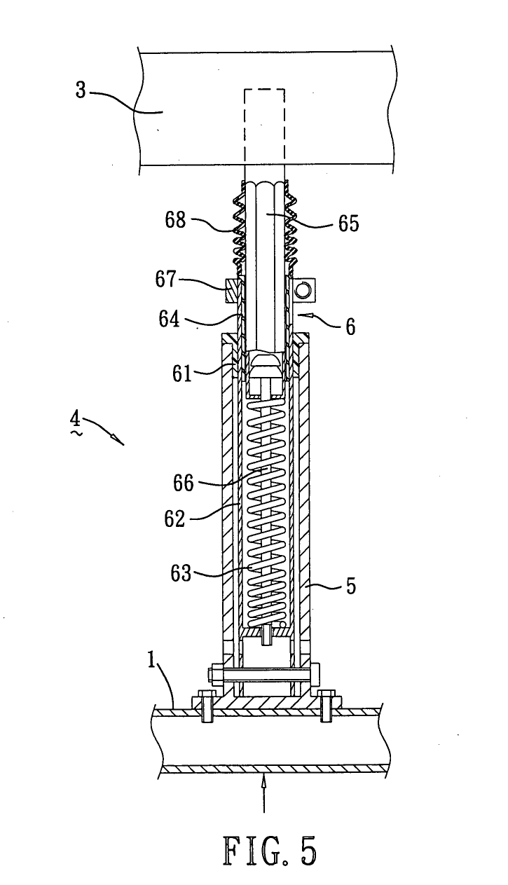

Referring to FIG. 5, when the vehicle body 1 is subjected to a shock, the central rod 66 moves upwardly relative to the inner tube 65 so that the spring 63 is compressed.

With this invention thus explained, it is apparent that numerous modifications and variations can be made without departing from the scope and spirit of this invention. It is therefore intended that this invention be limited only as indicated by the appended claims.

1. A motor vehicle comprising:
a wheeled vehicle body;
a driving device for driving said vehicle body to move on the ground;
a seat; and
a shock-absorbing device for supporting said seat on said vehicle body, said shock-absorbing device including
a vertical mounting tube fixed on said vehicle body, and
a damping unit disposed between said mounting tube and said seat such that said seat can move vertically on said mounting tube and such that said damping unit can retard vertical movement of said seat relative to said mounting tube.

2. The motor vehicle as claimed in claim 1, wherein said damping unit includes:
a vertical outer tube disposed fixedly within said mounting tube;
a vertical inner tube disposed vertically and movably within and projecting upwardly from said outer tube; and
a spring disposed between said inner and outer tubes so as to bias said inner tube to move upwardly relative to said outer tube.

3. The motor vehicle as claimed in claim 1, wherein each of said inner and outer tubes is formed with an integral horizontal plate therein, said horizontal plates of said inner and outer tubes defining cooperatively a spring-receiving chamber therebetween, said spring being configured as a coiled compression spring that is disposed within said spring-receiving chamber and that has an upper end pressing against said horizontal plate of said inner tube, and a lower end pressing against said horizontal plate of said outer tube.

4. The motor vehicle as claimed in claim 3, further comprising a vertical central rod extending through said coiled compression spring and having a lower end fastened to said horizontal plate of said outer tube, and an upper end that extends through said horizontal plate of said inner tube and that is formed with a flange unit which extends radially and outwardly therefrom and which abuts against a top surface of said horizontal plate of said inner tube so that said inner tube is biased by said coiled compression spring to move upwardly to a predetermined position relative to said outer tube.

5. The motor vehicle as claimed in claim 2, wherein said inner and outer tubes are made of metal, said damping unit further including:
an upper bushing made of rubber and disposed between an upper end of said outer tube and said inner tube so as to reduce noise resulting from vertical movement of said inner tube relative to said outer tube; and
a locking member for locking said upper bushing on said outer tube.

6. The motor vehicle as claimed in claim 5, wherein said locking member is configured as a C-shaped clamp, and includes:
a C-shaped retaining ring sleeved around said outer tube and having two terminal ends, each of which is formed with a hole;
a bolt extending through said holes in said terminal ends of said C-shaped retaining ring; and
a nut engaging said bolt.

7. The motor vehicle as claimed in claim 5 wherein said upper bushing is formed with a central bore having a non-circular cross-section, said inner tube being received fittingly within said upper bushing so as to prevent rotation of said inner tube relative to said upper bushing.

8. The motor vehicle as claimed in claim 2, wherein each of said mounting tube and said outer tube has a lower end that is formed with two holes, said motor vehicle further comprising a horizontal positioning bolt that extends through said holes in said lower ends of said mounting tube and said outer tube, and a nut engaging said positioning bolt so as to fix said outer tube within said mounting tube.

9. The motor vehicle as claimed in claim 2, wherein said mounting tube and said outer tube are made of metal, said damping unit further including a lower bushing that is made of a plastic material and that is disposed between an upper end of said mounting tube and said outer tube so as to provide a stable joint between said mounting tube and said outer tube.
